(19) United States
(12) Patent Application Publication
(10) Pub. No.: US 2020/0296961 A1
(43) Pub. Date: Sep. 24, 2020

(54) HIGH CONCENTRATE FOMESAFEN HERBICIDE FORMULATIONS

(71) Applicant: Helena-Agri Enterprises, LLC, Collierville, TN (US)

(72) Inventors: Johnnie R. ROBERTS, Arlington, TN (US); Emily Gum, Memphis, TN (US)

(21) Appl. No.: 16/894,183

(22) Filed: Jun. 5, 2020

Related U.S. Application Data
(63) Continuation-in-part of application No. 15/262,683, filed on Sep. 12, 2016, now Pat. No. 10,701,933.
Application No. 15/262,683 is a continuation of application No. 15/237,035, filed on Aug. 15, 2016, now abandoned.
(60) Provisional application No. 62/207,110, filed on Aug. 19, 2015.

(51) Int. Cl. A01N 41/10; A01N 57/20; A01N 37/36

(52) U.S. Cl. CPC A01N 41/10; A01N 37/36; A01N 57/20

(57) ABSTRACT

The invention relates to compositions containing the non-salt form of the herbicide fomesafen solubilized with at least one surfactant selected from the group consisting of fatty amine, alkanolamine, fatty amine alkoxylate and alkoxylated quaternary ammonium compounds. Advantages provided by these compositions include higher active ingredient levels, improved cold temperature stability, and enhanced weed control performance.

### RELATED APPLICATION

This application is a continuation-in-part of U.S. application Ser. No. 15/262,683 filed Sep. 12, 2016, which is a continuation of U.S. application Ser. No. 15/237,035 filed Aug. 15, 2016, which claims benefit to U.S. Provisional application Ser. No. 62/207,110 filed Aug. 19, 2015, which all are incorporated by reference in its entirety.

### BACKGROUND OF THE INVENTION

Fluorine containing diphenyl ether derivatives with applications as herbicides were first disclosed in European Patent 3416 and U.S. Pat. No. 4,384,135 by Cartwright et. al. which are both incorporated by reference in their entirety for all useful purposes. One of the more useful compounds that came out of this discovery is 5-[2-chloro-4-(trifluoromethyl) phenoxy]-N-methylsulfonyl-2-nitrobenzamide, which carries the common name fomesafen. Fomesafen is used in a number of commercially available products either alone or in combinations with other herbicides. Fomesafen has the following chemical formula:

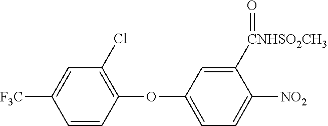

Recently there has been renewed research and additional applications for fomesafen due to its usefulness as a tool for managing weeds that have developed resistance to other herbicides. Enhancing the weed control efficacy and ease of application of fomesafen are desirable goals for this herbicide and are met with a number of difficulties and limitations. One difficulty that must be overcome is the poor water solubility of fomesafen. Fomesafen has a water solubility of only 50 mg/liter. This makes the preparation of concentrated water solutions that can be further diluted by the end user impractical. Fomesafen exhibits significantly greater solubility in organic solvents such as acetone, xylene, methylene chloride, and methanol. However, the flammability and/or toxicity of these solvents make them unsuitable for the preparation of concentrates. The most cost efficient way to address this limitation is to convert the fomesafen into a water soluble salt by reacting it with either sodium hydroxide or potassium hydroxide. This makes possible the preparation of water based formulations of the salt form of fomesafen up to 22.8% (21.7% fomesafen acid equivalent). While it is possible to increase the concentration of fomesafen salt in water to levels higher than 22.8%, such formulations become unstable in colder temperatures and are not practical for commercial use. In addition, pH of these compositions must be maintained at levels of 7.5 or higher. These alkaline pH ranges can have a negative impact on the weed control performance of both the fomesafen and other herbicides that are jointly applied with it. It is also established that the current commercial salt formulations of fomesafen have physical compatibility problems with other herbicides and fertilizers that are mixed with it.

Nevill et al. (US 2002/0004457) (Nevill) which is incorporated by reference in its entirety, discloses a very broad disclosure of surfactants in paragraphs [0077]-[0079] and as follows:
Suitable surface-active compounds are, depending on the nature of the active compounds under a) and b) to be formulated, nonionic, cationic and/or anionic surfactants and surfactant mixtures having good emulsifying, dispersing and wetting properties.
Examples of suitable anionic, nonionic and cationic surfactants are listed, for example, in WO 97134485, on pages 7 and 8.
The surfactants conventionally used in the art of formulation and which can also be used in the preparation of the herbicidal compositions according to the invention are described, inter alia, in “McCutcheon's Detergents and Emulsifiers Annual” MC Publishing Corp., Ridgewood, N.J., 1981, Stache, H., “Tensid-Taschenbuch” [Surfactant Handbook], Carl Hanser Verlag, Münich/Vienna, 1981 and M. and J. Ash. “Encyclopedia of Surfactants”, Vol I-III, Chemical Publishing Co., New York, 1980-81.
Suitable surface-active compounds are, depending on the nature of the active compounds under a) and b) to be formulated, nonionic, cationic and/or anionic surfactants and surfactant mixtures having good emulsifying, dispersing and wetting properties. Examples of suitable anionic, nonionic and cationic surfactants are listed, for example, in WO 97/34485 on pages 7 and 8. The surfactants conventionally used in the art of formulation and which can also be used in the preparation of the herbicidal compositions according to the invention are described, inter alia, in ‘Mc Cutcheon's Detergents and Emulsifiers Annual” MC publishing Corp., Ridgewood, N.J., 1981, Stache, H., “Tensid-Taschenbuch” [Surfactant Handbook], Carl Hanser Verlag, Munich/Vienna, 1981 and M. and J. Ash, “Encyclopedia of Surfactants”, Vol I-III, Chemical publishing Co., New York, 1980-81.

Nevill does recognize the criticality of selecting the surfactant.

### SUMMARY OF THE INVENTION

We have surprisingly discovered that it is now possible to prepare concentrated solutions of fomesafen in the non-salt form mixed with a surfactant selected from the group consisting of fatty amine, alkanolamine, fatty amine alkoxylate and alkoxylated quaternary ammonium compounds. The selection of the surfactant is critical. This water solubilized fomesafen may in turn be used to produce novel herbicide formulations that address the limitations of conventional fomesafen salt formulations that are now used commercially. Cold temperature stable concentrates of fomesafen up to about 65% by weight can be produced by this invention. This means that it is now possible to produce fomesafen formulations that deliver significantly more active ingredient than the current commercial products. This in turn provides consumers the advantages of reduced application rates, storage, handling, and costs.

We have also found that the formulations resulting from this invention provide superior compatibility and weed control with mixed and applied jointly with other herbicide products such as glyphosate and paraquat. These advantages may reduce or eliminate the need to add other components to the spray application (such as, but not limited to, adjuvants) for this purpose. The mild pH ranges possible for this composition (pH 6.0-7.5) also reduce the potential for eye irritation. Additional applications for this invention include novel formulations in combination with other herbicides such as, but not limited to, glyphosate, metolachlor, S-metolachlor, and acetochlor.

The composition according to the invention can also contain fertilizers, herbicides, fungicides, insecticides, plant regulators, plant nutritional products, macronutrients, micronutrients, humectants, acids, such as inorganic acids and/or organic acids.

Another object is to apply the agriculture composition according to the invention in a band or (starter) application, broadcast application or strip placement application. A band or starter application is the placement of the agricultural formation in the same area as the seed. A broadcast application is the general distribution of the agricultural composition over the entire soil surface. A strip placement is the placement of the agricultural composition in narrow strips. Crops will differ with placement and spacing. For example, spacing in sugarcane is 60″ and with multiple applications could be placed about 2″ to about 12″ at plant in the drill or placed on the soil surface with supplement applications after cane has been planted.

The articles “a” and “an” are used herein to refer to one or to more than one (i.e., to at least one) of the grammatical object of the article. By way of example, “an element” means one element or more than one element.

When ranges are used, all the numbers included in the range are covered. For example, if the range is from 1 to 5, would include 1, 2, 3, 4, 5 and decimals, such as 1.1, 1.2, 1.3, 1.4, 1.5, 1.6, 1.7, 1.8, 1.9 etc.

As used herein, the term “and/or” includes any and all combinations of one or more of the associated listed items. “About” as used herein when referring to a measurable value such as an amount, a temporal duration, and the like, indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

The above summary of the present invention is not intended to describe each disclosed embodiment or every implementation of the preset invention. The detailed description that follows more particularly exemplifies illustrative embodiments.

### DETAILED DESCRIPTION OF THE INVENTION

The preparation of concentrated non-salt formulations of fomesafen is accomplished by solubilizing this herbicide in specific surfactants rather than in solvents or water. The specific surfactants are selected from the group consisting of fatty amine, alkanolamine, fatty amine alkoxylate and alkoxylated quaternary ammonium compounds.

The following primary surfactants work as solubilizing surfactants for non-salt fomesafen, individually and in combination.

Fatty amines including, but not limited to:
Cocoamine and oleylamine;

Alkanolamines including, but not limited to:
Diethanolamine and triethanolamine;

Alkoxylated amines including, but not limited to:
Fatty amine alkoxylates such as tallow amine alkoxylates;

Alkoxylated quaternary ammonium compounds.

The following secondary surfactants can be included to enhance beneficial properties such as compatibility and efficacy, but do not work as solubilizing surfactants for non-salt fomesafen.

Alcohol alkoxylates including, but limited to:
Branched or linear;
Those containing ethylene oxide or propylene oxide;

Alcohol alkoxylate sulfates;

Alkylphenol alkoxylates, including, but not limited to:
Nonylphenol and octylphenol such as octylphenol polyglycol ether;
Those containing ethylene oxide or propylene oxide;

Alkylaryl sulfonates, including but not limited to:
Docecylbenzenesulfonates;

Amine oxides;

Betaine derivatives;

Carboxylated alcohols;

Ethoxylated fatty acids;

Ethoxylated fatty esters, ethers and oils, including but not limited to:
Castor oil polyglycol ether;

Fatty esters;

Glycerol esters;

Phosphate ester surfactants including, but not limited to:
Phosphate esters of alcohol alkoxylates;
Phosphate esters of alkylphenol alkoxylates;

Sarcosine derivatives;

Silicone-based surfactants;

Sorbitan derivatives including, but not limited to:
Sorbitan esters;
Alkoxylated sorbitan esters;

Sucrose and glucose derivatives including, but not limited to:
Alkylpolyglucosides;

Sulfates and sulfonates of alkoxylated alkylphenols;

Sulfates of alcohols;

Tristyrylphenol alkoxylates;

Polyethoxylated aliphatic phenols;

Polymers of ethylene or propylene oxides; or

Ethoxylated triglycerides and ethoxylated seed oils.

It is noted that non-ionic surfactants, anionic surfactants, amphoteric surfactants and certain cationic surfactants do not work. The invention can be practiced without any these surfactants. The surfactants disclosed by Nevill are very generic see paragraph nos. [0078] and [0079]:
Examples of suitable anionic, nonionic and cationic surfactants are listed, for example, in WO 97/34485, on pages 7 and 8.
The surfactants conventionally used in the art of formulation and which can also be used in the preparation of the herbicidal compositions according to the invention are described, inter alia, in “McCutcheon's Detergents and Emulsifiers Annual” MC Publishing Corp., Ridgewood, N.J., 1981, Stache, H., “Tensid-Taschenbuch” [Surfactant Handbook], Carl Hanser Verlag, Munich/Vienna, 1981 and M. and J. Ash, “Encyclopedia of Surfactants”, Vol I-III, Chemical Publishing Co., New York, 1980-81.

The following surfactants listed in Nevill do not work and are excluded from the invention:

Ca dodecylbenzenesulfonate,

Castor oil polyglycol ether and

Octylphenyl polyglycol ether.

The disclosed composition required to practice this invention comprise of 1-65% preferably 10-40% and more preferably 20-30% of the herbicide fomesafen in the non-salt form solubilized with 1-70% and preferably 20-50% by weight and most preferably 30-40% by weight with surfactants. Once solubilized, water may be added as diluent.

The pH of this composition should be in the range of 2.0-7.5 with the preferred range being 6.5-7.0. Acidic compounds may be used to lower the pH into the preferred range. These include, but are not limited to: acetic acid, lactic acid, maleic acid, succinic acid, sulfuric acid, hydrochloric acid, phosphoric acid, or nitric acid. Alkaline compounds may be used to raise the pH into the preferred range. These include, but are not limited to: sodium hydroxide, potassium hydroxide, ammonium hydroxide, calcium hydroxide, magnesium hydroxide, or sodium bicarbonate.

The composition(s) disclosed may be used in the range of 0.05-10.0% and preferably 0.125-5.00% and most preferably 0.25-2.50% by weight in a water and/or fertilizer based spray mixtures. These spray mixtures may also contain other herbicides as well as fungicides, insecticides, plant growth regulators, or plant nutritional products such as, macronutrients, and micronutrients, humectants, acids, such as inorganic acids and/or organic acids and fertilizer products.

The following is a list of herbicides, fungicides, insecticides, plant regulators, plant nutritional products that can be used according to the invention include, but are not limited to:

Accord Concentrate,

Accord XRT II,

Authority First DF,

Authority XL,

Avaris,

Axilo BZM,

Axilo Mix 5,

Axilo Mn,

Cadet,

Classic,

Cobalt,

Cobra,

CoRoN 10-0-10 B,

CoRoN Full Bor,

CoRoN 25-0-0-0.5B,

Durango DMA,

ENC,

First Rate,

Fusilade DX,

Gly Star Gold,

Glyfos Original,

Glyfos Xtra,

Glystar Plus,

Glytrel MnP,

Gramoxone,

Halex GT,

Headline AMP,

Headline EC,

Headline SC,

Honcho Plus,

Hoss Ultra,

Kickstand MN,

K-Leaf,

Leverage 2.7,

Leverage 360,

Liberty 280 SL,

Marvel,

Megafol,

Nucleus 0-0-15,

Paraquat Firestorm,

Pendimethalin,

Powermax,

Prowl H2O,

Quadris Top,

Quilt Xcel,

Resource,

Rodeo,

Select Max,

Showdown,

Stratego YLD,

TapOut,

Tempest,

Touchdown CT2,

Touchdown Total SL,

Traxion SL,

Utilize, or

Viathon.

| | | Active | | |
|---|---|---|---|---|
| Product | Type | Ingredient(s) | Fomesafen specific language | Broad herbicide tank mix language |
| Accord | herbicide | glyphosate | none | This product may be used in tank mix |
| Concentrate | | | | combination with other herbicide |
| | | | | products to broaden the spectrum of |
| | | | | vegetation controlled. |
| Accord XRT II | herbicide | glyphosate | none | For residual weed control or to |
| | | | | broaden the weed control spectrum, |
| | | | | tank mix this product with other |
| | | | | herbicides. |
| Authority First | herbicide | cloransulam- | none | Authority First DF Herbicide may be |
| DF | | methyl, | | applied alone or in tank mix |
| | | sulfentrazone | | combination with other herbicides |
| | | | | registered for . . . application to |
| | | | | soybeans. |
| Authority XL | herbicide | clorimuron ethyl, | none | Authority XL may be applied alone |
| | | sulfentrazone | | or in tank mix combinations with |
| | | | | other registered soybean herbicides. |
| Avaris | fungicide | azoxystrobin, | none | Avaris may be applied as a foliar |
| | | propiconazole | | spray in alternating spray programs |
| | | | | or in tank mixes with other crop |
| | | | | protection products. |
| Axilo BZM | nutritional | Mn, Zn, B, Mo | none | Axilo BZM is compatible with a |
| | | | | wide range of fertilizers and |
| | | | | pesticides . . . Can form a stable mixture |
| | | | | with glyphosate, other pesticides and |
| | | | | foliar fertilizers. |
| Axilo Mix 5 | nutritional | Fe, Mn, Mg, Cu, | none | Axilo Mix 5 is compatible with a |
| | | Zn, B, Mo | | wide range of fertilizers and |
| | | | | pesticides . . . |
| Axilo Mn | nutritional | Mn | none | Axilo Mn is compatible with a wide |
| | | | | range of fertilizers and pesticides . . . |
| Cadet | herbicide | fluthiacet-methyl | none | Cadet is compatible with most |
| | | | | commonly used herbicides, |
| | | | | insecticides, fungicides, and spray |
| | | | | adjuvants. |
| Classic | herbicide | mcpa, 2,4-D, | CLASSIC ® may be tank mixed | |
| | | Dicamba | with: 0.75-1.25 pt/acre “Flexstar” | |
| | | | 0.75-1.5 pt/acre “Reflex” . . . | |
| Cobalt | insecticide | chlorpyrifos, | none | Cobalt Advanced is compatible with |
| | | gamma, | | insecticides, herbicides, miticides, |
| | | cyhalothrin | | and fungicides and non-pressure |
| | | | | fertilizer solutions commonly used |
| | | | | except for alkaline materials . . . |
| Cobra | herbicide | lactofen | TO DELAY HERBICIDE | |
| | | | RESISTANCE Avoid the use of | |
| | | | herbicides that have a similar target | |
| | | | site mode of action in consecutive | |
| | | | years. Other Group 14 herbicides | |
| | | | (PPO inhibitors) include acifluorfen | |
| | | | (Ultra Blazer ®) and fomesafen | |
| | | | (Flexstar ®, Reflex ®). | |
| CoRoN 10-0-10B | nutritional | Cl, N, Potash, B | none | none |
| CoRoN Full Bor | nutritional | N, B | none | Coron Full Bor is compatible with |
| | | | | most pesticides and other |
| | | | | fertilizers . . . |
| CoRoN 25-0-0- | nutritional | N, B | none | none |
| 0.5B | | | | |
| Durango DMA | herbicide | glyphosate | To control emerged weeds as a | |
| | | | postemergence application, apply | |
| | | | this product in a tank mix | |
| | | | with . . . fomesafen (Flexstar) | |
| | | | to control emerged Amaranthys | |
| | | | spp . . . To control emerged | |
| | | | ragweed species, apply this product | |
| | | | in a tank mix with . . . fomesafen | |
| | | | (Flexstar). | |
| ENC | nutritional | Potash, Phosphate, | none | Ele-Max Nutriend Concentrate is |
| | | N, Cl, Fe, Cu, Mn, | | compatible with most fungicides, |
| | | Zn, B, Mo, Co | | insecticides and herbicides . . . |
| First Rate | herbicide | cloransulam- | Tank Mix Options: For weeds not | |
| | | methyl | listed for postemergence control | |
| | | | with FirstRate, the herbicides listed | |
| | | | below may be used per label | |
| | | | instructions: Flexstar, Reflex | |
| Fusilade DX | herbicide | fluazifop-p-butyl | Tank Mix Options: For weeds not | |
| | | | listed for postemergence control | |
| | | | with FirstRate, the herbicides listed | |
| | | | below may be used per label | |
| | | | instructions: Flexstar, Reflex | |
| Gly Star Gold | herbicide | glyphosate | Soybeans Refer to table below for | |
| | | | tank mixtures that may be applied | |
| | | | before, during or after planting in | |
| | | | conventional tillage systems, into a | |
| | | | cover crop, established sod or in | |
| | | | previous crop residue. TANK | |
| | | | MIXES: Flexstar, Reflex | |
| Glyfos Original | herbicide | glyphosate | none | none |
| Glyfos Xtra | herbicide | glyphosate | none | none |
| Glystar Plus | herbicide | glyphosate | Soybeans Refer to table below for | |
| | | | tank mixtures that may be applied | |
| | | | before, during or after planting in | |
| | | | conventional tillage systems, into a | |
| | | | cover crop, established sod or in | |
| | | | previous crop residue. TANK | |
| | | | MIXES: Flexstar, Reflex | |
| Glytrel MnP | nutritional | Mn, phosphate | none | none |
| Gramoxone | herbicide | paraquat | Gramoxone SL may be tank | |
| | | | mixed with the following | |
| | | | herbicides: . . . Flexstar. | |
| Halex GT | herbicide | s-matolachlor, | none | none |
| | | glyphosate, | | |
| | | mesotrione | | |
| Headline AMP | fungicide | metconazole, | none | none |
| | | pyraclostrobin | | |
| Headline EC | fungicide | pyraclostrobin | none | Headline fungicide can be tank mixed |
| | | | | with most recommended fungicides, |
| | | | | insecticides, herbicides, liquid |
| | | | | fertilizers, biological control |
| | | | | products, adjuvants, and additives as |
| | | | | specified in table 2. |
| Headline SC | fungicide | pyraclostrobin | none | Headline SC fungicide can be tank |
| | | | | mixed with most recommended |
| | | | | fungicides, insecticides, herbicides, |
| | | | | liquid fertilizers, biological control |
| | | | | products, adjuvants, and additives as |
| | | | | specified in table 2. |
| Honcho Plus | herbicide | glyphosate | This product may also be tank- | |
| | | | mixed with the following | |
| | | | products . . . Flexstar, Reflex | |
| Hoss Ultra | herbicide | glyphosate | none | none |
| Kickstand MN | nutritional | Mn | none | none |
| K-Leaf | nutritional | Potash | none | none |
| Leverage 2.7 | insecticide | imidacloprid, | none | Leverage 2.7 may be combined with |
| | | cyfluthrin | | foliar-applied fungicides, herbicides |
| | | | | and insecticides/miticides. |
| Leverage 360 | insecticide | imidacloprid, | none | Leverage 360 Insecticide may be |
| | | cyfluthrin | | combined with foliar-applied |
| | | | | fungicides, herbicides and |
| | | | | insecticides/miticides. |
| Liberty 280 SL | herbicide | glufosinate | TANKMIX PARTNER FOR | |
| | | | LIBERTY 280 SL HERBICIDE IN | |
| | | | LIBERTYLINK SOYBEANS | |
| | | | Flexstar, Reflex | |
| Marvel | herbicide | fomesafen, | none | Marvel Herbicide is compatible with |
| | | fluthiacet-methyl | | most commonly used herbicides, |
| | | | | insecticides, fungicides, and spray |
| | | | | adjuvants. |
| Megafol | nutritional | Potash, N | none | Megafol can be tank mixed with |
| | | | | pesticides, fertilizers or other |
| | | | | chemicals. |
| Nucleus 0-0-15 | nutritional | Potash, Cl | none | none |
| Paraquat | herbicide | paraquat | Improved Control of Perennial and | |
| Firestorm | | | Annual Broadleaf Weeds Tank | |
| | | | mixing with . . . Reflex Herbicide | |
| | | | will help improve control when | |
| | | | perennial broadleaf weeds such as | |
| | | | Canada thistle, bindweed, | |
| | | | dandelion, etc., or difficult to | |
| | | | control annual broadleaf weeds | |
| | | | such as giant ragweed or | |
| | | | morningglory are present. | |
| Pendimethalin | herbicide | pendimethalin | none | Helena Pendimethalin should be |
| | | | | tank mixed or followed by a |
| | | | | postemergence herbicide application. |
| Powermax | herbicide | glyphosate | This product may also be tank- | |
| | | | mixed with the following | |
| | | | products . . . Flexstar, Reflex, | |
| | | | fomesafen | |
| Prowl H2O | herbicide | pendimethalin | none | Prowl H2O should be tank mixed or |
| | | | | followed by a postemergence |
| | | | | herbicide application. |
| Quadris Top | fungicide | azoxystrobin, | none | none |
| | | difenconazole | | |
| Quilt Xcel | fungicide | azoxystrobin, | none | Quilt Xcel may be applied as a foliar |
| | | propiconazole | | spray in alternating spray programs |
| | | | | or in tank mixes with other crop |
| | | | | protection products. |
| Resource | herbicide | flumicloracm | Approved tank mixes are indicated | |
| | | pentyl ester | in Table 5 . . . Flexstar | |
| Rodeo | herbicide | glyphosate | none | For residual weed control or an |
| | | | | alternate mode of action, tank mix |
| | | | | this product with other herbicides. |
| Select Max | herbicide | clethodim | Table 10. SELECT MAX TANK | |
| | | | MIXES WITH BROADLEAF | |
| | | | HERBICIDES . . . Flexstar HL . . . | |
| Showdown | herbicide | glyphosate | none | Showdown may be applied in |
| | | | | combination with any herbicide |
| | | | | registered for the same site, timing, |
| | | | | and method of application. |
| Stratego YLD | fungicide | trifloxystrobin, | none | none |
| | | prothioconazole | | |
| TapOut | herbicide | clethodim | Table 10. TAPOUT TANK MIXES | |
| | | | WITH BROADLEAF | |
| | | | HERBICIDES . . . Flexstar HL . . . | |
| Tempest | insecticide | bifenthrin, | none | Tempest Dual-Action Insecticide |
| | | imidacloprid | | may be applied in tank mixtures with |
| | | | | other products approved for use on |
| | | | | registered crops. |
| Touchdown CT2 | herbicide | glyphosate | Touchdown CT2 can be tank mixed | |
| | | | with the following | |
| | | | products: . . . Flexstar, Reflex | |
| Touchdown Total | herbicide | glyphosate | Touchdown Total can be tank | |
| SL | | | mixed with the following | |
| | | | products: . . . Flexstar, Reflex | |
| Traxion SL | herbicide | glyphosate | Traxion can be tank mixed with the | |
| | | | following products: . . . Flexstar, | |
| | | | Reflex | |
| Utilize | nutritional | N | none | none |
| Viathon | fungicide | Potassium | none | none |
| | | phosphite, | | |
| | | tebuconazole | | |

The invention is applicable to all non-salt based fomesafen herbicides used in both agricultural and non-agricultural applications. Non-agricultural applications would include use in forestry, vegetation management, aquatics, ornamentals, turf, and home pest control.

The composition according to the invention can also contain

Macronutrients,

Micronutrients,

Humectants,

Inorganic acids,

Organic acids,

Various elements, which are normally drawn from the soil, are known to be essential to plant nutrition. These elements include: nitrogen (N), phosphorus (P), potassium (K), sulfur (S), calcium (Ca), magnesium (Mg), iron (Fe), manganese (Mn), copper (Cu), cobalt (Co), zinc (Zn), boron (B), nickel (Ni), molybdenum (Mo), and chlorine (Cl). Of these elements, nitrogen, phosphorus, potassium, sulfur, calcium, and magnesium are needed by plants in relatively large quantities and are therefore called macronutrients. The remaining members of the group (iron, manganese, copper, cobalt, zinc, boron, nickel, molybdenum, and chlorine) are known as micronutrients since they are required in very small amounts for plant growth.

Fertilizers can include macronutrients and micronutrients.

Supplying a plant's major nutrient needs (nitrogen, phosphorus, potassium-N—P—K) is most effective and economical via soil application. However, foliar application has proven to be an excellent method of supplying plant requirements for secondary macronutrients (sulfur, calcium, magnesium) and micronutrients (carbon (C), hydrogen (H), and oxygen (O), nitrogen (N), phosphorus (P) and potassium (K), while supplementing N—P—K needs for short and/or critical growth stage periods. Additionally, the so called micronutrients, also commonly provided by mineral fertilizers are: boron (B), chlorine (Cl), copper (Cu), iron (Fe), manganese (Mn), zinc (Zn) and molybdenum (Mo). Foliar application refers to the application of plant nutrients to above-ground plant parts. Foliar fertilization programs prolong the fertilizing application period, providing a continuous supply of nutrients when crop demand is at a maximum, and can be an economical way to boost yield.

In fertilization programs, sulfate metal salts (e.g., zinc sulfate, manganese sulfate, and copper sulfate) are an economical source affording both sulfur and micronutrients.

Humectants have also been used to help retain water within the soil and plant tissue. These features make the incorporation of a humectant into a foliar fertilizer potentially beneficial to the needs of the plant. Inorganic acids, include mineral acids selected from the group consisting of nitric acid, phosphoric acid, sulfuric acid, and mixtures thereof; and phosphorous acid or ammonia or a mixture thereof or phosphorous acid and/or ammonia can also be used in combination with the mineral acids.

Organic acids are preferably fulvic acid, humic acid, citric acid and carboxylic acid, preferably C₁ to C₂₀ carboxylic acid.

The composition(s) disclosed may be used in the range of 0.05-5.0% of water based spray.

### EXAMPLES

TABLE 1
Fomesafen % active at low and high range

| | Ex1 | Ex2 | Ex3 | Ex4 | Ex5 | Ex6 | Ex7 | Ex8 |
|---|---|---|---|---|---|---|---|---|
| Ingredient | wt % | wt % | wt % | wt % | wt % | wt % | wt % | wt % |
| Fomesafen, non-salt form | 10.0 | 10.0 | 30.0 | 30.0 | 50.0 | 50.0 | 60.0 | 70.0 |
| Fatty amine alkoxylate surfactants | 30.0 | 70.0 | 70.0 | — | 20.0 | 30.0 | — | — |
| Alkanolamine surfactants | — | — | — | 70.0 | 30.0 | 20.0 | 40.0 | 30.0 |
| Water balance | 60.0 | 20.0 | — | — | — | — | — | — |
| Total | 100.0 | 100.0 | 100.0 | 100.0 | 100.0 | 100.0 | 100.0 | 100.0 |
| Physical observations | clear | clear | hazy | clear | clear | clear | clear | lumpy |
| | amber | amber | amber | yellow | amber | amber | amber | yellow |
| | liquid | liquid | liquid | liquid | liquid | liquid | liquid | solids |
| Soluble liquid | yes | yes | yes | yes | yes | yes | yes | no |

TABLE 2
Single and combination surfactants

| | Ex9 | Ex10 | Ex11 | Ex12 | Ex13 | Ex14 | Ex15 | Ex16 | Ex17 |
|---|---|---|---|---|---|---|---|---|---|
| Ingredient | wt % | wt % | wt % | wt % | wt % | wt % | wt % | wt % | wt % |
| Fomesafen, non-salt form | 10.0 | 10.0 | 30.0 | 30.0 | 30.0 | 30.0 | 30.0 | 50.0 | 50.0 |
| Alcohol alkoxylate | — | — | 20.0 | — | — | — | — | — | — |
| surfactants | | | | | | | | | |
| Alkanolamine surfactants | — | — | 20.0 | 70.0 | — | — | — | 30.0 | 20.0 |
| Fatty amine surfactants | — | — | — | — | 70.0 | — | — | — | — |
| Fatty amine alkoxylate | 20.0 | 70.0 | 30.0 | — | — | 70.0 | — | 20.0 | 30.0 |
| surfactants | | | | | | | | | |
| Alkoxylated quaternary | — | — | — | — | — | — | 70.0 | — | — |
| ammonium surfactants | | | | | | | | | |
| Water balance | 70.0 | 20.0 | — | — | — | — | — | — | — |
| Total | 100.0 | 100.0 | 100.0 | 100.0 | 100.0 | 100.0 | 100.0 | 100.0 | 100.0 |
| Physical observations | clear | clear | clear | clear | hazy | hazy | clear | clear | clear |
| | amber | amber | amber | yellow | amber | amber | amber | amber | amber |
| | liquid | liquid | liquid | liquid | liquid | liquid | liquid | liquid | liquid |
| Soluble liquid | yes | yes | yes | yes | yes | yes | yes | yes | yes |

TABLE 3
Preferred embodiment comparisons

| | Ex18 | Ex19 | Ex20 | Ex21 |
|---|---|---|---|---|
| Ingredient | wt % | wt % | wt % | wt % |
| Fomesafen, non-salt | 29.00 | 29.00 | 29.00 | 29.00 |
| form | | | | |
| Fatty amine alkoxylate | 20.00 | — | — | — |
| surfactants | | | | |
| Alkanolamine | 11.75 | 11.75 | 11.75 | — |
| surfactants | | | | |
| Secondary surfactants | 12.65 | 12.65 | — | — |
| Glycol & water | 26.60 | 46.60 | 59.25 | 71.00 |
| balance | | | | |
| Total | 100.00 | 100.00 | 100.00 | 100.00 |
| Physical observations | clear | clear | clear | white foamy solids |
| | amber | amber | yellow | suspended in clear |
| | liquid | liquid | liquid | liquid above thick |
| | | | | white sediment |
| Soluble liquid | yes | yes | yes | no |

### CONCLUSION

The data above clearly showed the criticality of selecting the correct surfactant so that the fomesafen can be soluble. It is demonstrated above that the surfactants being alkoxylated fatty amines (see examples 1-3, 5, 6, 9-11, 14, and 16-18 above), alkanolamines (examples 4-8, 11-12, and 16-20 above) and alkoxylated quaternary ammonium compounds (example 15) were unexpectedly superior with respect to being soluble and clear liquids. In addition, it is demonstrated above that the surfactants being fatty amines (example 13) produce a soluble but hazy liquid. Table 1 shows the use of different amounts of the active from 10 to 70%. It is noted that example 8 with 70% fomesafen did not work. Table 2 shows formulas with single and 0combinations of different surfactants. Without the use of these surfactants the fomesafen would not solubilize. The above data shows that the use of certain surfactants with fomesafen produces a clear soluble liquid. Examples 3, 13 and 14 worked but were not quite as good, being hazy but still soluble. Table 3 shows that the use of surfactants is critical, comparing an example with no surfactants (example 21) to examples with mixtures of surfactants (examples 18-20).

All the references described above are incorporated by reference in their entirety.

I claim:

1) A composition comprising about 8 to about 65% fomesafen herbicide in the non-salt form and solubilized with at least one surfactant selected from the group consisting of fatty amine, alkanolamine, fatty amine alkoxylate and alkoxylated quaternary ammonium salt.

2) The composition as claimed in claim 1, adjusted to a pH range of 2.0-7.5.

3) The composition as claimed in claim 1, diluted in water or fertilizer at the range of 0.05-10.0%.

4) The composition as claimed in claim 2, diluted in water or fertilizer at the range of 0.05-10.0%.

5) The composition as claimed in claim 1, further comprises a pesticide product.

6) The composition as claimed in claim 4, further comprises a pesticide product.

7) The composition as claimed in claim 1, further comprises a fertilizer product.

8) The composition as claimed in claim 4, further comprises a combined with fertilizer product.

9) The composition as claimed in claim 1, further comprises pesticide and fertilizer products.

10) The composition as claimed in claim 4, further comprises pesticide and fertilizer products.

11) The composition as claimed in claim 1, further comprises a herbicide glyphosate, metolachlor, or acetohchlor.

12) The composition as claimed in claim 1, further comprises a herbicide glyphosate, metolachlor, or acetohchlor.

13) The composition as claimed in claim 1, further comprises a herbicide S-metolachlor.

14) The composition as claimed in claim 4, further comprises a herbicide S-metolachlor.

15) The composition as claimed in claim 1, wherein the following surfactants are excluded: Ca dodecylbenzenesulfonate, Castor oil polyglycol ether or Octylphenyl polyglycol. ether.

16) A process of treating a plant which comprises applying the composition as claimed in claim 1 to a ground surface where a plant is planted.

17) A process of treating a plant which comprises spraying the composition as claimed in claim 3 to a ground surface where a plant is planted.
